(19) United States
(12) Patent Application Publication
(10) Pub. No.: US 2009/0306944 A1
(43) Pub. Date: Dec. 10, 2009

(54) DEVICE AND METHOD FOR CALCULATING AND SUPPLYING A DRUG DOSE

(75) Inventors: Stefan Willmann, Dusseldorf (DE); Karsten Höhn, Woodlands (AU); Andreas Edginton, Leverkusen (DE); Walter Schmitt, Neuss (DE)

Correspondence Address: NORRIS, MCLAUGHLIN & MARCUS, 875 THIRD AVE, 18TH FLOOR, NEW YORK, NY, 10022, US

(73) Assignee: BAYER TECHNOLOGY SERVICES GMBH, Leverkusen (DE)

(21) Appl. No.: 12/306,105

(22) PCT Filed: Jun. 16, 2007
(86) PCT No.: PCT/EP07/05327

§ 371 Date: May 4, 2009

(30) Foreign Application Priority Data
Jun. 20, 2006 (DE) 10 2006 028 232.9

(51) Int. Cl. G06F 17/10; G06F 19/00

(52) U.S. Cl. 703/2

(57) ABSTRACT

The invention relates to a device for use in the clinical/therapeutical field for the patient-individual optimization of the dosage and/or the dosage scheme of a drug based on rational, mathematical models which take into consideration possible physiological variations that are due to the illness or other particularities of the patient and the interaction with co-drugs that are administered at times close to each other. The invention also relates to the supply of said drug dose by means of a dosage device.

The present invention relates to an apparatus for use in the clinical/therapeutic field for patient-specific optimization of the dose and/or dose plan of a medicament on the basis of rational, mathematical models which take account of any debilitation-dependent physiological changes and other special features of the patient, as well as the interaction with co-medicaments supplied at approximately the same time, and to the provision of this medicament dose by means of a dosing apparatus.

It is generally known that a range of different individual factors of the patient can influence the absorption, distribution and excretion of a medicament (the so-called pharmacokinetics) and therefore also its active time profile (the pharmacodynamics). The most important influencing factors include the weight, age or sex of the patient and the functionality of his excretion organs such as the liver or kidneys. The need for patient-specific dosing occurs frequently in clinical-therapeutic practice, but in general is implemented only inadequately. Specific patient populations such as children or elderly patients require adapted doses, because of ageing or debilitation-dependent differences in the absorption, distribution and excretion of medicaments, in order to ensure the safety and effectiveness of the medicament therapy.

Patient-specific doses are particularly problematic when there is a need for dose adaptation resulting from the interaction with one or more further medicaments which is or are supplied to the same patient approximately at the same time (co-medication). In a situation such as this, which occurs frequently in clinical practice, the possibility of mutual influencing exists, for example when two substances are broken down via the same metabolic path in the liver or are substrates of the same transporter protein. Processes such as induction or inhibition of enzymes may, for example, lead to the need to vary and adapt the dose during the therapy.

There are many reasons why medicament doses are not given on a patient-specific basis in clinical practice. In the case of solid, orally given administration forms such as tablets or capsules, which are preferred over other forms of administration such as intravenous medicament administration in clinical use, medicaments which can be dosed easily are frequently not available. In the case of tablets or capsules, it is generally possible only to vary the dose by consuming a plurality of tablets or capsules, or by splitting the tablet. The capability for real individualization of the medicament dose is therefore, however, greatly restricted. Liquid formulations can still be dosed relatively easily by stipulating a defined liquid volume, for example by means of a measurement cup or dropper. However, only a relatively small number of medicaments are available in liquid form on the market.

A further important reason for the use of non-patient-specific medicament doses is the lack of time in the clinical-therapeutic environment. The time which a practitioner has available in clinical routine for the selection of a dose for each patient is on average only a few minutes. If dose adaptation is required, the doctor will take the information relating to the dose to be administered—if available—from the package label or from the literature, in the form of books, reports or tables, which generally involves a considerable amount of time. Furthermore, tabulated information relating to the dose does not provide the capability to take account of specific factors of the individual patient. The available time interval for the practitioner, which is only short, to deal with the question of optimized dosing also carries the risk of dosing errors, which do not occur only rarely in everyday clinical use.

US 2002/0091546 describes a computer-based method which manages clinically/therapeutically relevant information such as patient data, as well as data relating to the indications and active substances, and is available to the practitioner as decision aid for dosing and therapy planning.

US 2001/0001144 discloses a computer-based method for therapy management for the pharmacist or practitioner which uses patient data and data relating to the medicament to be administered to calculate a medicament dose. This document also describes the consideration of interactions with other medicaments. In order to define the patient-specific dose, the patient data for the patient to be treated is compared with the data for previous patients with similar characteristics and symptom (patient data matching).

The two methods described in US 2002/0091546 and US 2001/0001144 have the disadvantage that the information used is evidence-based, that is to say it is predominantly built on empirical knowledge, for example published case studies. Both methods are therefore greatly restricted in the safety of their use, to be precise to those patients who are sufficiently similar and comparable to already known cases.

Software for the management of the workflow in a hospital pharmacy is likewise known from the prior art, and is commercially available. By way of example, the AutoMed's Efficiency WorkPath™ System of the AmerisourceBergen Technology Group, the PKon Pharmacy Management System from SRS Systems or the Pharmacy Management Software from RX-Link may be mentioned by way of example. However, until now, the existing software products such as these have not provided the capability to take account of and dynamically describe patient-specific characteristics on the anthropometric/physiological, pathophysiological, biochemical or genetic level, and the time-dependent interaction with co-medicaments in the individual dose calculation.

In order to allow valid predictions to be made with regard to the concentration/time profile and the effect/time profile of a medicament in a specific patient, without having to make use of comparable case studies, complex physiology-based simulation models are required. Simulation models such as these are known from the literature and are described in detail, for example, in WO2005/033982 for mammalian organisms (including the human organism). Methods which use simulation models such as these in combination with physiological, anatomical and genetic information relating to the patient to be treated to determine individually optimized medicament doses are described in WO2005/33334, WO2005/684731, WO2005/116854 and DE 10 2005 028 080.

A first important precondition for reliable prediction of the pharmacokinetics and pharmacodynamics of a medicament is an accurate estimate of the elimination rate (the so-called clearance) for the medicament in the respective patient. These metabolization and excretion rates may vary greatly from one person to another, for example because of different influencing factors such as age, sex, race, the presence of pathophysiological circumstances such as kidney or liver insufficiency, or individual genetic differences. The variability of the activity of the enzymes in the Zytochrom CYP450 system, for example, may, as is known, be a reason why the effects and side-effects of a medicament may differ widely from one patient to another with the same dose. Genetic polymorphisms are known for a plurality of enzymes in this class, which considerably decrease or completely preclude the activity. Furthermore, in the case of children and old people, the age-dependent activity of individual enzymes and transporter proteins must be taken into account. Methods for scaling the clearance in a child based on the clearance of an adult, with knowledge of the breakdown and elimination processes involved and their age-dependent activity are known from the literature [A. N. Edginton, W. Schmitt, B. Voith, S. Willmann: “A Mechanistic Approach for the Scaling of Clearance in Children”, Clin. Pharmacokin. (accepted for publication 2005), S. Bjorkman: “Prediction of drug disposition in infants and children by means of physiologically based pharmacokinetic (PBPK) modelling: theophylline and midazolam as model drugs.” Br J Clin Pharmacol. 2005 June;59(6):691-704.].

In the meantime, biological test methods (so-called Gene chips) have become available, by means of which the activities of specific pharmacokinetically relevant enzymes can be determined experimentally.

The excretion rates can be scaled in specific sub-populations such as renally or hepatically insufficient patients, for example using clinical parameters such as creatinine-clearance or the status of the liver enzymes.

The second important precondition is correct study of the distribution volume, which results essentially from substance characteristics such as lipophilia and free fraction in the plasma as well as the individual body composition (water, fat and protein content), which are likewise dependent on the age and condition of the patient. Certain debilitations, for example those which involve malnutrition or poor use of the ingested nutrition, change the composition of the body in terms of the water, food and protein content. This is known according to the prior art.

Apparatuses for defining and providing a patient-specific medicament dose are known and commercially available. Examples of such so-called Unit Dose systems are the Cadet® Systems from the AccuChart™ company, the Medical Packaging System from Medical Packaging Inc., SwissLog's PillPicker Systems or the AutoMed® System from AmerisourceBergen Technology Group and others. DE 103 09 473 likewise describes an apparatus for producing an individual, fixed medicament dose. However, this patent specification does not disclose the method used to determine the optimum dose for each patient.

Methods and apparatuses which take adequate account of the time-dependent processes such as enzyme induction or inhibition in dose determination are, however, not known from the prior art.

The present invention is therefore based on the object of developing a safe and rapid point of care apparatus which determines a medicament dose which is optimally matched to the individual patient and then provides it to the practitioner or to the patient at the right time. The determination of the patient-specific medicament dose should take into account not only relevant parameters of the patient of an anthropometric/physiological, pathophysiological, biochemical and/or genetic type, but also information and parameters which are specific to the medicament to be administered. If further medicaments are being administered to the patient in the course of his treatment, pharmacokinetic and pharmacodynamic influences resulting from co-medication should also be taken into account. The apparatus according to the invention is also intended to take account of the interaction in the dose calculation and is also intended to emit a warning to the practitioner in the event of incompatibility of active-substance combinations and existing contraindications. In addition to dose optimization, that is to say optimization of the amount to be administered, the apparatus according to the invention is also intended to be able to minimize any undesirable side-effects resulting from medicament interactions by the use of an optimized dose plan, that is to say by stipulation time intervals between the administration of the medicaments involved. The optimum dose of the medicament should be provided close in time to the point of interest (point of care), that is to say for example in a hospital or in the doctor's practice.

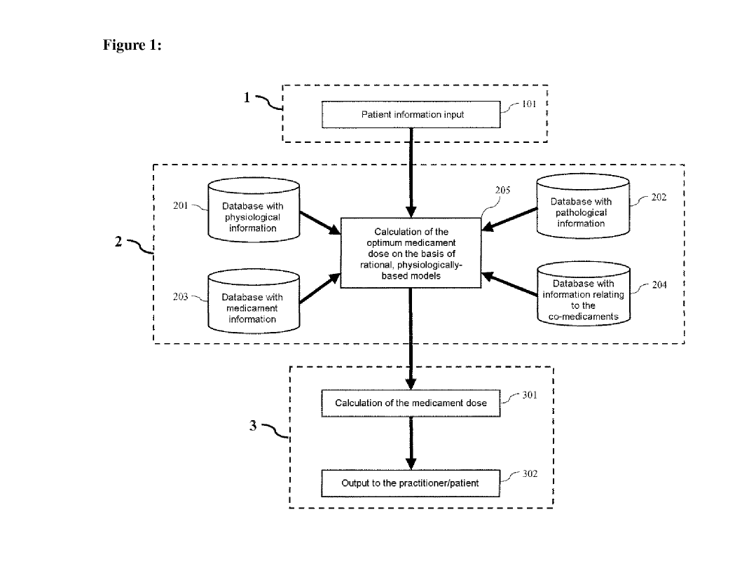

These problems are solved by the apparatus according to the invention. The stated problem is solved by an apparatus which comprises an input unit (1), a calculation unit (2) and an automatic apparatus, connected thereto, for dosing of medicaments (3) (FIG. 1).

The input unit (1) is used to record the relevant individual patient information (101) for the patient to be treated.

By way of example, the individual parameters relating to the patient include two parameters from the body weight (BW), body size (H) or body mass index (BMI=BW/H²). They also include age, sex, race, parameters which together with the body weight make it possible to produce a statement about the body composition, such as the lean body mass (LBM), fat free body mass (FFBM) or total body fat mass (TBFM). They also include genetic information such as expression or activity of metabolizing enzymes or transporter proteins, information about the functionality of the excretion organs such as the kidneys and liver, or information about existing allergies or incompatibilities relating to food stuffs or medicaments.

Furthermore, in the case of co-medication, the dose plans of all the other medicaments being administered are relevant and are therefore included in the input parameters. In addition to co-medicaments in the actual sense, the contents of food stuffs can also influence the pharmacokinetics of active substances and therefore lead to similar undesirable interactions with medicaments. This is the case, for example, with St. John's wort or green tea, and with grapefruit juice. Food stuff contents such as these must then be treated analogously to the co-medicaments.

In this case, all conventional data input systems for computers may be used as an input unit. A handheld device is particular preferable for use in the clinic or in the doctor's practice. Individual parameters relating to the patient (101) to be treated are generally input by the practitioner. It is also feasible for the required patient-specific information to be stored in a portable, computer-legible storage medium, for example a smartcard, and to be read by a reader, or else are already available to the treating doctor in the form of a digital medical record.

The calculation unit (2) calculates to the optimum medicament dose and, if appropriate, the optimum dose plan. It comprises computer-implemented software and the hardware required to run the program. The hardware is generally a commercially available PC which is either connected directly to the input appliance, as in the case of a laptop computer with a built-in keyboard or smart-card reader, or is positioned locally and is connected to the input unit (server). In this case, in principle, all conventional transmission techniques, both wire-based and wire-free methods, are suitable and feasible. Wire-free transmission of the patient information entered via the handheld input module of the smart-card reader is particularly preferable.

The software not only manages all the information that is relevant for calculation of the optimum medicament dose, using one or more databases, but also calculates the patient-specific dose. This information which is relevant for calculating the medicament dose can be subdivided into physiological (or anthropometric) information (201), pathological information (202), medicament-specific information (203) and, if appropriate, information relating to additionally administered medicaments, so-called co-medicaments (204).

Analogously to the individual patient information items (101), relevant physiological and anthropometric (201) and pathophysiological information (202) in each case includes, for example, age, sex, race, body weight, body size, body mass index, lean body mass fat free body mass, gene expression data, debilitations, allergies, medication, kidney function and liver function.

Relevant pathophysiological information (202) is, in particular, debilitations, allergies, kidney function and liver function.

By way of example, the medicament information (203) includes lipophilia, free plasma fraction, blood plasma ratio, distribution volume, clearance, type of clearance, clearance proportions, type of excretion, dose plan, transporter substrate, PD end point and side effects.

Relevant medicament information (203) is, in particular, the recommended therapeutic dose (based on the manufacturer's details), pharmacodynamic end point, clearance (overall clearance as blood or plasma clearance in a reference population or a reference individual) and the type of clearance (hepatic metabolic, biliary, renal, etc.) and the proportions of the individual processes in the overall clearance, kinetic parameters of active transporters, if the medicament is a substrate for one or more active transporters, and physicochemical and pharmacokinetic information such as lipophilia, unbound fraction in the plasma, plasma proteins to which the medicament binds, blood/plasma distribution coefficient, or distribution volume.

In the case of co-medications, the corresponding information as mentioned above, relating to all the further administered medicaments, is contained in the database (204) for the co-medicaments.

Empirical knowledge which can be obtained, for example, by research of case studies can likewise be an additional component of the databases with medicament information or information relating to co-medicaments.

The calculation of the optimum dose and, if applicable, of the optimum dose plan is carried out on the basis of the individual patient data using a rational mathematical model for calculating the pharmacokinetic and pharmacodynamic behavior of the medicament to be administered based on the information (205) contained in the databases. In this context, by way of example, rational mathematical models may be allometric scaling functions of physiology-based pharmacokinetic models.

In one preferred embodiment of the invention, a physiologically-based pharmacokinetic/pharmacodynamic simulation model is used to calculate the individual dose. The dynamically generated physiologically-based simulation model which is described in detail in WO2005/633982 is particularly preferred.

One particular advantage of the use of a physiology-based simulation model from WO2005/633982 is the capability to simulate simultaneous administration of a plurality of medicaments and their interaction dynamically. In this context, dynamically means that, in the event of the interaction, the kinetics of the two (or if applicable also a plurality of) interacting substances can be taken into account. This is advantageous over a static analysis in which, for example, an enzyme or a transporter is entirely or partially constrained without any time dependency, since the dynamic simulation allows optimization of the dose plan. One possible result of such optimization of the dose plan is, for example, to maintain a maximum time interval of, for example, 12 hours (in the case of a single administration daily) for the administration of two interacting substances, in order to minimize the mutual influence.

Processes such as enzyme inhibition or induction are known to be dependent on time, so that interaction efforts based on these processes are likewise time-dependent. In specific cases, these dynamic effects which act over a time scale of several days or weeks can results in the need for dose matching of a medicament in the course of the therapy. A simple static analysis or just the issue of a warning to the practitioner when simultaneously administering medicaments which influence one another, as are known from the prior art, is not consistent with such complex, dynamic effects.

In summary, the dynamically coupled simulation models described in WO2005/633982 for the basis for optimization of the dose plan. For example, an iterative method can be used to simulate the influence of the time offset in the administration of the medicament and the co-medicament which interacts therewith on the desired pharmacodynamic and the undesirable side effects, and therefore to optimize the timing of the parallel administration of the two medicaments.

During operation of the apparatus according to the invention, the optimum medicament dose which is obtained for the patient under consideration is transmitted to the automatic dosing apparatus (3). The location of the automatic dosing apparatus (3) is not particularly restricted and, for example, may be the hospital pharmacy in the case of a hospital. The information relating to the optimum medicament dose can be transmitted to the automatic dosing apparatus (3) with or without the use of wires, or else can be stored/transmitted electronically, or transmitted in paper form, just as a prescription. In the automatic dosing apparatus, the medicament dose is calculated (301) on the basis of the conventional known methods and, after production, is provided (302) to the practitioner or patient. In the case of liquid formulations, apparatuses for volumetric or gravimetric measurement of liquids may be used as automatic dosing apparatuses, and the Unit-Dose systems, which are known according to the prior art, may be used for solid administration forms.

In one particularly simple embodiment, the patient information (101) comprises only the indication of the age and weight of the patient, in particular the indication of the age and weight of a child. As further physiological/anthropometric parameters (201), mean values are assumed for a child of the corresponding age, and pathological changes are ignored in the simplest embodiment. The dose is calculated from the scaling of the clearance using a method as described in the literature from the value for adults, for example the method described in A. N. Edginton, W. Schmitt, B. Voith, S. Willmann: “A Mechanistic Approach for the Scaling of Clearance in Children”, Clin. Pharmacokin. (accepted for publication 2005) (see also example A).

The particular advantages of the apparatus according to the invention, which can be used directly in the clinic or doctor's practice as a point of care solution, depending on the embodiment, are the time saving for the practitioner and the considerably reduced susceptibility to errors. Both aspects make a significant contribution to making medicament therapy safer and more efficient. The apparatus according to the invention can, furthermore, advantageously be integrated in existing software solutions which manage the work flow in a hospital pharmacy. A further advantage of the apparatus according to the invention and of the method on which it is based is that this for the first time makes it possible to reasonably take account of interactions which occur in the case of co-medication, and in this way to allow parallel administration of a plurality of medicaments, optimized in time and quantity, and matched to the respective situation.

The invention will be explained by means of the following examples, although it is not restricted to these examples.

### EXAMPLES

One major aspect of the apparatus according to the invention is the calculation of an optimum medicament dose taking account of individual factors and parameters relating to the patient to be treated. The following examples show how these factors and parameters influence the pharmacokinetics, and demonstrate the validity of the physiology-based pharmacokinetic simulation. The examples are based on simulations using the physiology-based pharmacokinetic model PK-Sim® (Version 3.0), developed by Bayer Technology Services. Two of the examples relate to the substance Ciprofloxacin, although this should not be understood as implying any restriction to this substance or to substances in the same substance class.

A: Calculation of a Medicament Dose in Children

The calculation of a medicament dose in children is therapeutically highly relevant. Until now, the vast majority of all medicaments have been licensed only for use in adults, since there has been no information relating to the effects and side-effects in children. The pediatrician is faced with the dilemma of in principle having a highly effective medicament available but not being able to use this for a child. In this case, it is necessary to consider whether the unlicensed use or the withholding of the medicament therapy with the corresponding medicaments will cause more damage to the patient.

However, medicaments are then frequently administered to children without being licensed (unlicensed) or not within the licensed indications (off-label), in some cases with serious consequences. The infantile organism differs in terms of the composition of water, proteins and fat and with regard to the activity of the excretion organs (in particular the liver and kidneys) to a major extent from the organism of an adult, therefore necessarily resulting in pharmacokinetic and pharmacodynamic differences. For exact dose matching, it is necessary to take account not only of the age-dependent differences in the body composition, which in particular influence the distribution volume, but also of the activity of the excretion organs, which leads to the clearance being age-dependent. The age-dependency of the clearance is in this case of major importance with regard to dose matching since, depending on the age and the process of excretion, the clearance in a child may differ by more than one order of magnitude from the value for an adult. A combined method is used in this example, which scales the clearance as a function of age, on the basis of the value in an adult, to the prospective value in a child. This method uses two approaches, which are known from the literature. One approach is allometric scaling of the clearance on the basis of the body weight of the child by means of an allometric equation [Anderson B J, Meakin G H. Scaling for size: some implications for paediatric anesthesia dosing. Paediatr Anaesth 2002; 12(3):205-219., Holford N H. A size standard for pharmacokinetics. Clin Pharmacokinet 1996; 30(5):329-332]:

$${CL}_{child} = {CL}_{adult} \times {( \frac{B {W}_{child}}{B {W}_{adult}} )}^{0.75}$$

In this case, CL_{Child} means the clearance of the child, CL_{adult} the clearance in an adult (both in non-normalized flow units such as ml/min), BW_{child} means the body weight of the relevant child and BW_{adult} the body weight of the adult (which is generally fixed at 70 kg). Apart from the reference data of the adult, this allometric approach requires the body weight of the child to be treated as the only input. This allometric approach has the disadvantage that the same intrinsic activities of the excretion processes are assumed in the adult and in the child, with the differences between the child and the adult being caused solely by the size difference. Particularly in new-born and young children, however, the metabolizing enzymes in the liver or the elimination system in the kidneys, for example, have not yet been fully developed, however. This enzyme ontogeny is process-dependent, that is to say the various liver enzymes reach the activity level of an adult at different times. The literature describes mechanistic models which describe the age-dependent development of different elimination processes from the new-born child to the adult. Even clearance values of prematurely born children, which once again represent a specific sub-population in terms of the maturity of the liver and kidneys, can be predicted using mechanistic models such as these [A. N. Edginton, W. Schmitt, B. Voith, S. Willmann: “A Mechanistic Approach for the Scaling of Clearance in Children”, Clin. Pharmacokin. 2006; 45 (7) 683-704]. However, in contrast to the simple allometric approach, the components of all the elimination processes involved in the overall clearance are required for mechanistic scaling of the clearance, in addition to a clearance reference value in the adult [A. N. Edginton, W. Schmitt, B. Voith, S. Willmann: “A Mechanistic Approach for the Scaling of Clearance in Children”, Clin. Pharmacokin. 2006; 45 (7) 683-704]. It is also necessary to take account of the fact that the effect and side-effects of the medicament can be influenced by age-dependent variations in the unbound fraction in the plasma. In order to take account of this effect, the indication of the plasma protein binding in the adult and the indication of which plasma protein mainly binds the medicament are required. The age-dependent components in the blood plasma for the most important plasma proteins such as serum albumin α-glycoprotein are known [Darrow D C, Cary M K. The serum albumin and globulin of newborn, premature and normal infants. J Pediatr 1933; 3: 573-9., McNamara P J, Alcorn J. Protein binding predictions in infants. AAPS PharmSci 2002; 4(1): 1-8], so that differences in the free fractions can be calculated and taken into account. This mechanistic approach can be carried out using computer software.

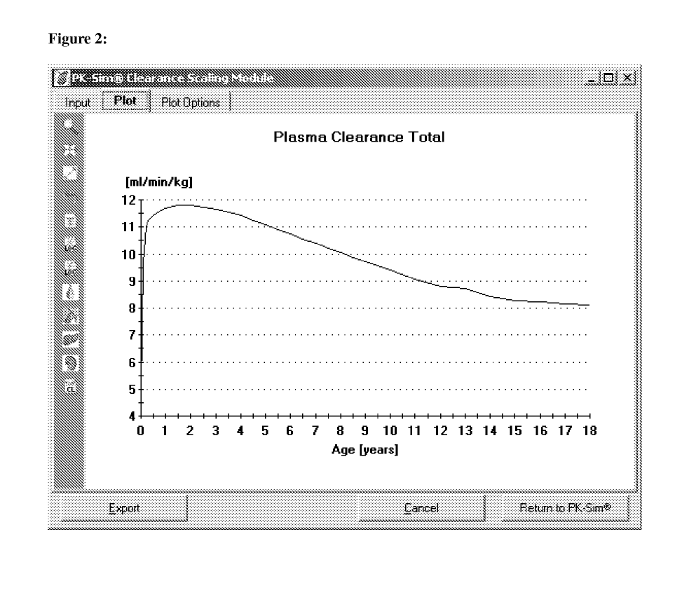

FIG. 2 shows the output window with the age-dependent clearance curve in a child resulting from the mechanistic model [A. N. Edginton, W. Schmitt, B. Voith, S. Willmann: “A Mechanistic Approach for the Scaling of Clearance in Children”, Clin. Pharmacokin. 2006; 45 (7) 683-704]. Input parameters are the reference values in the adult for the unbound fraction in the plasma (plasma fu), billiary (plasma CLbil), hepatic (CLhep) and renal clearance (CLren), the relative components of the enzymatic processes on the hepatic clearance and the age of the child, and the indication of the main binding protein in the plasma (albumin or glycoprotein).

The two described approaches can now advantageously be combined. A direct comparison of the two methods allows the definition of a (process-dependent) threshold value for the age, in which the intrinsic activity had reached the level of the adult. In this example, this is shown for 15 different active substances from different indication fields. Table 1 shows the active substances, their break-down paths and the reference values for free fraction and the main binding protein in the plasma in an adult. These values are taken from the publication [A. N. Edginton, W. Schmitt, B. Voith, S. Willmann: “A Mechanistic Approach for the Scaling of Clearance in Children”, Clin. Pharmacokin. 2006; 45 (7) 683-704]:

TABLE 1

| | | Free fraction in the plasma |
|---|---|---|
| Active substance | Excretion process | and main binding protein |
| Gentamicin | Renal (100%) | 95% |
| Isepamicin | Renal (100%) | 95% |
| Alfentanil | CYP3A (100%) | 10% (α1-Glycoprotein) |
| Midazolam | CYP3A (100%) | 2% (Albumin) |
| Caffeine | CYP1A2 (85%), | 70% (albumin) |
| | CPY2E1 (13%), | |
| | Renal (2%) | |
| Ropivacaine | CYP1A2 (90%), | 5% (α1-Glycoprotein) |
| | CYP3A4 (9%), | |
| | Renal (1%) | |
| Morphine | UGT2B7 (90%), | 75% (Albumin) |
| | Renal (10%) | |
| Lorazepam | UGT2B7 (100%) | 8% (Albumin) |
| Fentanyl | CYP3A (90%), | 16% (α1-Glycoprotein) |
| | Renal (10%) | |
| Paracetamol | UGT1A6 (60%), | 95% (Albumin) |
| | sulfonation (30%), | |
| | CYP2E1 (5%), | |
| | Renal (5%) | |
| Theophylline | CYP1A2 (60%), | 55% (Albumin) |
| | CYP2E1 (25%), | |
| | Renal (15%) | |
| Ciprofloxacin | Renal [66% (25% | 70% (Albumin) |
| | filtration, 75% net | |
| | tubular secretion)], | |
| | CYP1A2 (16%), | |
| | Billiary (14%) | |
| Buprenorphine | UGT2B7 (75%), | 4% (Albumin) |
| | CYP3A4 (25%) | |
| Lidocaine | CYP1A2 (65%), | 30% (α1-Glycoprotein) |
| | CYP3A (32%), | |
| | Renal (3%) | |
| Levofloxacin | Renal (80%) | 70% (Albumin) |
| | UGT1A1 (10%) | |
| | Billiary (10%) | |

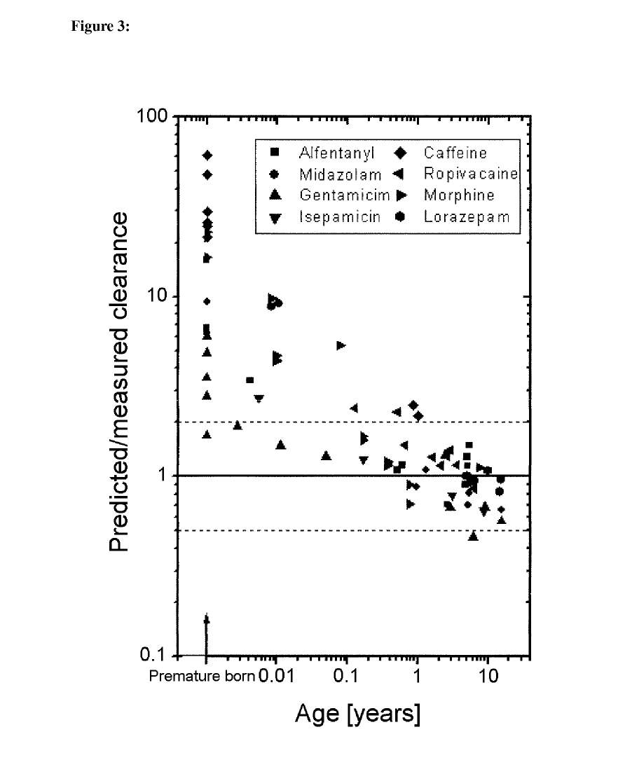

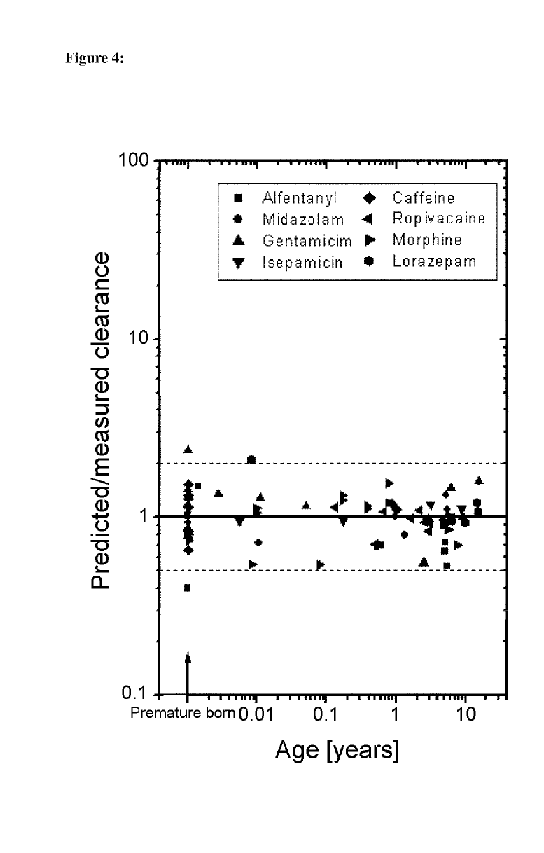

Predictions using these two approaches for these active substances are compared with experimentally measured clearance values in children in FIGS. 3 to 6. FIG. 3 shows the ratio of predicted to experimentally measured clearance in children as a function of the age using the example of substances which are predominantly eliminated via a single break-down path (gentamicin, isepamicin, alfentanil, midazolam, caffeine, ropivacaine, morphine and lorazepam). In this case, the prediction is based on the allometric scaling. FIG. 2 clearly shows that the allometric approach leads to a drastic overestimate of the clearance in a child up to an age of, on average, about one year, since the maturity of the liver and kidneys is ignored. The clearance prediction for the same substances when using the mechanistic model of Edginton et al. [A. N. Edginton, W. Schmitt, B. Voith, S. Willmann: “A Mechanistic Approach for the Scaling of Clearance in Children”, Clin. Pharmacokin. (accepted for publication 2005)] is illustrated in FIG. 4. In this case, children under an age of one year and the prematurely born also lie in a comparable scatter interval to the children who are older than one year. More detailed analysis of this data results in the following threshold values for the respective elimination processes for the age at which the intrinsic activity reaches the level of an adult:

| Excretion process | Threshold value (age) |
|---|---|
| Renal via glomerular filtration | 0 (new born) |
| Hepatic via CYP3A4 | 6 months |
| Hepatic via CYP1A2 | 6 months |
| Hepatic via UGT2B7 | 2 months |

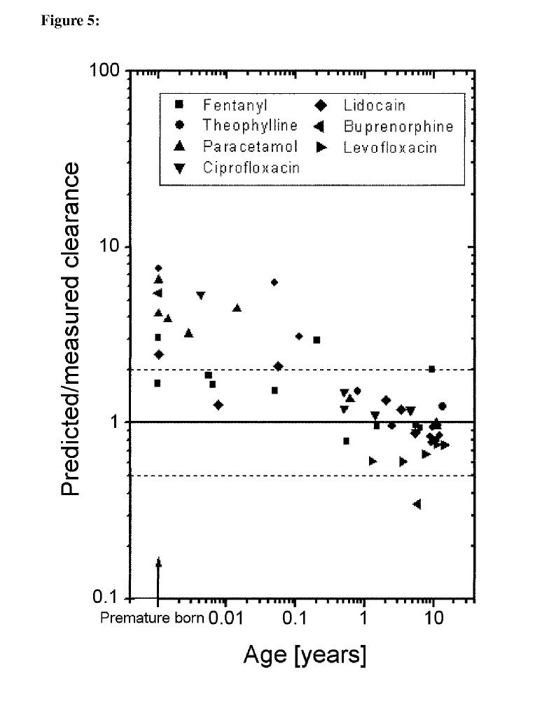

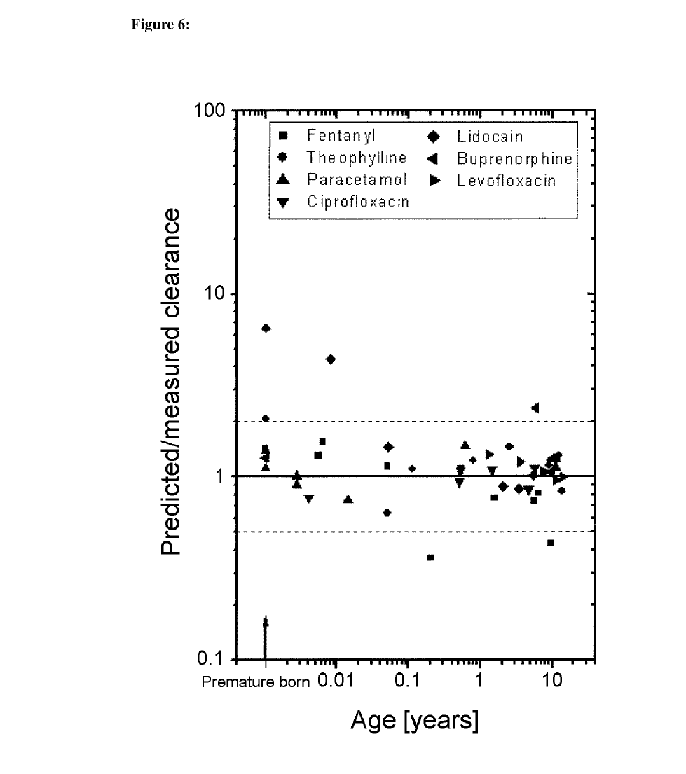

FIGS. 5 and 6 show the ratios of the predicted and experimentally measured clearance values in children as a function of age, by way of example for substances which are eliminated via combinations of different break-down paths (fentanyl, paracetamol, theophylline, ciprofloxacin, buprenorphine, lidocaine and levofloxacin). The prediction in FIG. 5 is once again based on the allometric approach, FIG. 6 shows the prediction based on the mechanistic model of Edginton et al. [A. N. Edginton, W. Schmitt, B. Voith, S. Willmann: “A Mechanistic Approach for the Scaling of Clearance in Children”, Clin. Pharmacokin. (accepted for publication 2005)]. In this case as well, it is once again clear that, from an age of about one year, the scatter of the two models is comparable, while below one year, the clearance prediction based on the mechanistic model is considerably better.

The two approaches can now advantageously be combined to form an overall model which provides a clearance scaling on the basis of mechanistic modeling such as [A. N. Edginton, W. Schmitt, B. Voith, S. Willmann: “A Mechanistic Approach for the Scaling of Clearance in Children”, Clin. Pharmacokin. (accepted for publication 2005)] for prematurely born, new-born and small children up to the process-specific threshold value, and carries out an allometric scaling process based on the individual body weight for children who are older than this threshold value. In the simplest case, a threshold value of one year is assumed for all processes, with this being the maximum value for all the processes considered. For substances whose break-down processes are not known in detail, only the allometric method can be used although, for safety reasons, this is then restricted to use in children who are older than one year.

B: Dosing in the Case of Renal Insufficiency: Example of Ciprofloxacin

This example shows how the diagnosis of “renal dysfunction” can affect the dosage of a renally excreted medicament (using the example of the antibiotic ciprofloxacin). The following physico-chemical parameters of ciprofloxacin were used as input parameters for the simulation: lipophilia (LogMA)=0.954, molar weight=331.3).

There are a number of studies using ciprofloxacin in patients with different extents of renal dysfunction [“DRUS”: Drusano et al., “Pharmacokinetics of Intravenously Administered Ciprofloxacin in Patients with Various Degrees of Renal Function” Antimicrob. Agents Chemotherap. 31(6), 860-864 (1987); “WEBB”: D. B. Webb et al. “Pharmacokinetics of ciprofloxacin in healthy volunteers and patients with impaired kidney functions”, J. Antimicrob. Chemotherap. 18Suppl.D, 83-87 (1986); “SHAH”: A. Shah et al. “Pharmacokinetics of intravenous ciprofloxacin in normal and renally impaired subjects” J. Antimicrob. Chemotherap, 38, 103-116 (1996)]. A blood parameter, the so-called creatinine clearance (CLₑᵣ), is used as a measure of the degree of renal dysfunction. This clearance is frequently also normalized with respect to the body surface area. The patients are typically classified in four groups, corresponding to the extent of renal dysfunction:

| Group | Degree of renal dysfunction | CL_{cr} [ml/min/1.73 m²] |
|---|---|---|
| A | Low | >90 |
| B | Mild | 60-90 |
| C | Moderate | 30-60 |
| D | Severe | <30 |

A virtual population comprising 500 individuals was produced using PK-Sim® for comparison with the real patient data. The age, sex, size and weight distribution of this virtual population corresponding to the actual comparison population, are summarized in Table 2:

TABLE 2
Ciprofloxacin studies with patients with renal dysfunction.

| | CL_{CR} Range | | | | | | | | | | |
|---|---|---|---|---|---|---|---|---|---|---|---|
| | [ml/min/ | | Sex | Age | BW | BH | Dose in | Cₘₐₓ | AUC | Vss | |
| Group | 1.73 m²] | N | M/F | [years] | [kg] | [cm] | the study | [mg/L] | [mg h/L] | [L/kg] | REF. |
| (A) | 102-150 | 8 | 8/0 | 27.1 [22-30] | 77.3 [61-89] | n.r. | 200 mg | 6.30 (1.77) | 7.46 (1.59) | 2.49 (0.46) | DRUS |
| | | | | | | | (iv 10 min.) | | | | |
| (B) | 68-87 | 5 | 5/0 | 36.0 [27-48] | 79.5 [67-109] | n.r. | 200 mg | 4.14 (1.05) | 7.60 (2.98) | 3.19 (1.26) | DRUS |
| | | | | | | | (iv 30 min.) | | | | |
| (C, D) | 13-57 | 11 | 10/1 | 43.6 [24-60] | 75.9 [51-98] | n.r. | 200 mg | 5.44 (0.82) | 13.3 (3.4) | 2.38 (0.62) | DRUS |
| | | | | | | | (iv 30 min.) | | | | |
| (D | 0 | 8 | 8/0 | 45.5 [33-55] | 69.0 [60-86] | n.r. | 200 mg | 5..39 (1.59) | 13.0 (3.6) | 2.73 (0.92) | DRUS |
| | | | | | | | (iv 30 min.) | | | | |
| (A) | 91-136 | 6 | 5/1 | 41 (16) | 71 (11) | 176 (11) | 100 mg | n.r. | 3.15 (1.42) | 2.73 (0.61) | WEBB |
| | | | | | | | (iv 5 min.) | | | | |
| (B, C) | 34-62 | 6 | 2/4 | 43 (14) | 70 (19) | 165 (6) | 100 mg | n.r. | 5.70 (1.74) | 2.00 (0.56) | WEBB |
| | | | | | | | (iv 5 min.) | | | | |
| (D) | 10-27 | 6 | 2/4 | 56 (7) | 65 (13) | 161 (7) | 100 mg | n.r. | 6.39 (1.25) | 1.82 (0.28) | WEBB |
| | | | | | | | (iv 5 min.) | | | | |
| (D) | 2-9 | 6 | 4/2 | 49 (15) | 64 (15) | 164 (8) | 100 mg | n.r. | 7.57 (4.55) | 2.10 (0.50) | WEBB |
| | | | | | | | (iv 5 min.) | | | | |
| (A) | >90 | 10 | 10/0 | 39.1 [32-46] | 87.0 [65-99] | 180 [168-196] | 400 mg | 3.80 (0.53) | 10.2 (1.9) | 2.19 (0.22) | SHAH |
| | | | | | | | (iv 1 h) | | | | |
| (B) | 61-90 | 11 | 6/5 | 50.1 [28-68] | 81.8 [51-111] | 171 [145-193] | 400 mg | 4.59 (0.92) | 15.4 (3.4) | 1.83 (0.27) | SHAH |
| | | | | | | | (iv 1 h) | | | | |
| (C) | 31-60 | 11 | 5/6 | 63.0 [32-64] | 81.1 [61-119] | 171 [155-193] | 400 mg | 5.35 (1.50) | 21.5 (5.6) | 1.61 (0.29) | SHAH |
| | | | | | | | (iv 1 h) | | | | |
| (D) | <31 | 10 | 4/6 | 51.7 [32-64] | 76.9 [56-98] | 163 [145-196] | 300 mg | 4.28 (0.90) | 30.1 (8.4) | 1.50 (0.23) | SHAH |
| | | | | | | | (iv 1 h) | | | | |

Data quoted as mean value (S.D.) or range [minimum-maximum]. iv: intravenous administration; n.r.: not reported.

The total cprofloxacin plasma clearance in healthy adults is approximately 7.6 ml/min/kg. Approximately ⅔ of intravenously administered ciprofloxacin is renally excreted without being changed (corresponding to a renal clearance of 5.0 ml/min/kg). In order to produce individuals with renal dysfunction of different extent in the virtual population, the renal clearance was interpolated linearly as a function of the creatinine clearance from 5.0 ml/min/kg in patients in group A (no renal dysfunction) to 0.0 ml/min/kg in individuals without any kidney function (FIG. 13a). Furthermore, renal dysfunction is generally associated with a reduction in the plasma proteins (for example the serum albumin “HSA”) which itself influences the unbound fraction of a substance in the plasma. The unbound fraction (fᵤ) depends on the volume component of serum albumin (f_{HSA}) as follows:

fᵤ=1/[(1−f_{HSA})+f_{HSA}+K_{HSA]}

In this case, K_{HSA} represents the albumin/plasma distribution coefficient. In healthy individuals, KHSA can be calculated by reorganization of the equation from the values for fᵤ (70%) and f_{HSA} (2.2%, corresponding to 4.0 g/dL) to give K_{HSA}=20.5. In individuals with reduced creatinine clearance (<15 ml/min), the serum albumin is reduced by about 30% (f_{HSA}=1.5%, corresponding to 2.8 g/dL) [Viswanathan et al., “Serum albumin levels in different stages of type 2 diabetic nephropathy patients”, Indian J Nephrol, 14,89-92 (2004)]. The free plasma function can be expressed, by linear interpolation, as a function of the creatinine clearance (see FIG. 13b).

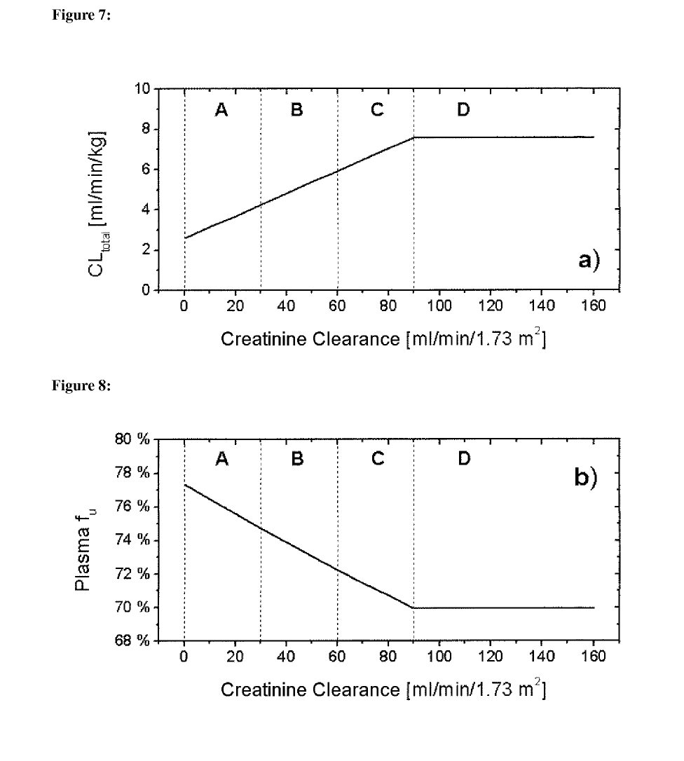

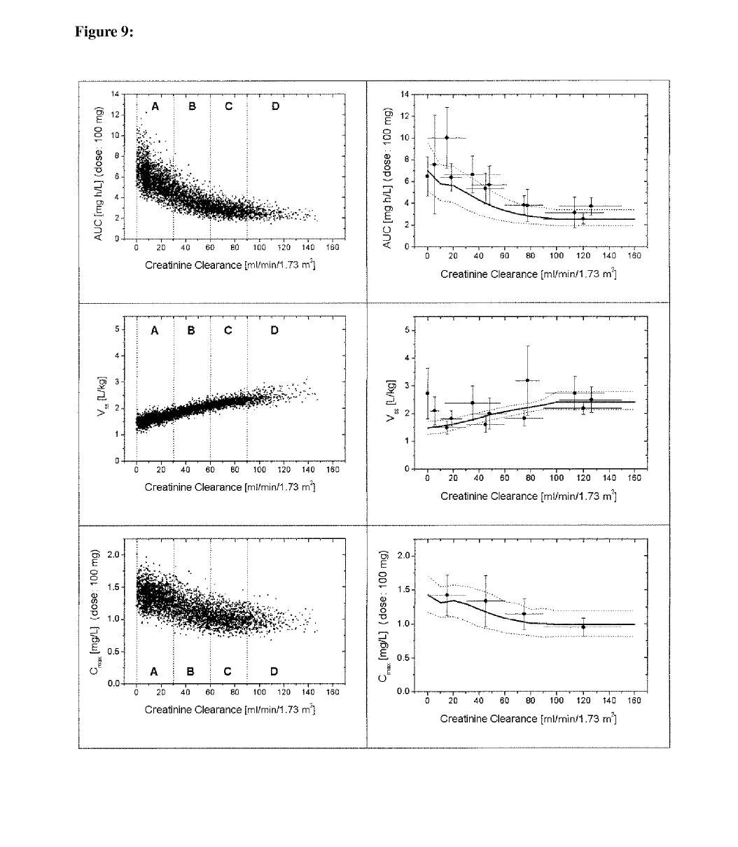

A creatinine clearance was now initiated stochastically for each virtual individual, from which. a renal clearance (FIG. 7) and a free fraction (FIG. 8) can be determined as input parameters for PK-Sim® on the basis of the curves illustrated in FIGS. 7 and 8. After the simulation of the ciprofloxacin pharmacokinetics in the virtual population, the results can be compared with those of the actual population (FIG. 9). The left-hand column of FIG. 9 shows the simulated dose-normalized exposition (AUC=area under the plasma-concentration-time curve), the distribution volume and the maximum dose-normalized concentration following a one-hour infusion for the virtual individuals. The right-hand column shows the corresponding results for the experimental studies (symbols, mean value and S.D.) together with the mean value (thick line) and the 5% and 95% percentiles (dashed lines) from the simulation. The comparison of the simulated with the experimentally determined pharmacokinetic parameters of ciprofloxacin in patients with renal dysfunction shows that the simulation is qualitatively and quantitatively able to correctly describe the influence of the reduced renal excretion on the pharmacokinetics. Dose matching can be derived directly from this description, from a substance-specific target variable (for example Cₘₐₓ or AUC).

C. Dosage for a Severely Overweight Patient: Example of Ciprofloxacin

Caldwell and Nilsen have published a case study for administration of ciprofloxacin in a severely overweight patient [Caldwell J B and Nielsen A K, Intravenous ciprofloxacin dosing in a morbidly obese patient, Annals of Pharmacotherapy 28 (1994)]. The male patient was 57 years old and weighed 226 kg at the time of the treatment. His kidney and liver functions were normal. The therapeutic dose was calculated on the basis of an estimate using further published cases of ciprofloxacin administration in overweight patients by LeBel et al. [LeBel M, Kinzig M, Allard S, Mahr G, Boivin G, Sorgel F. Ciprofloxacin disposition in obesity (abstract 601). Presentation at the 31. Interscience Conference on Antimicrobial Agents and Chemotherapy, Chicago, 29 Sep.-2 Oct. 1991]. The range of overweight patients described in this document weighed only 111±20 kg, however, that is to say on average less than half the severely overweight patient used by Caldwell and Nilsen. As a result of the empirical estimate, the patient was in each case given a single dose of 800 mg of ciprofloxacin as an intravenous infusion over 60 minutes twice daily, with a separation of 12 hours, over several days. In order to check the estimated dose, a blood sample was taken from the patient on the fourth day of the treatment, approximately 20 minutes after the end of an infusion, and the plasma level of ciprofloxacin was determined experimentally. The determined measured value was 4.2 mg/L [Caldwell J B and Nielsen A K, Intravenous ciprofloxacin dosing in a morbidly obese patient, Annals of Pharmacotherapy 28 (1994)]. This point measured value was in the therapeutically effective range and was below the plasma concentration of 10 mg/L that would be considered to be toxicologically critical.

Once again, the same physicochemical parameters of ciprofloxacin as in example B were used to simulate the ciprofloxacin administration in this severely overweight patient. The weight of the patient was set at 226 kg, and the body size (as a result of lack of information from the publication) was assumed to be normal, that is to say 176 cm.

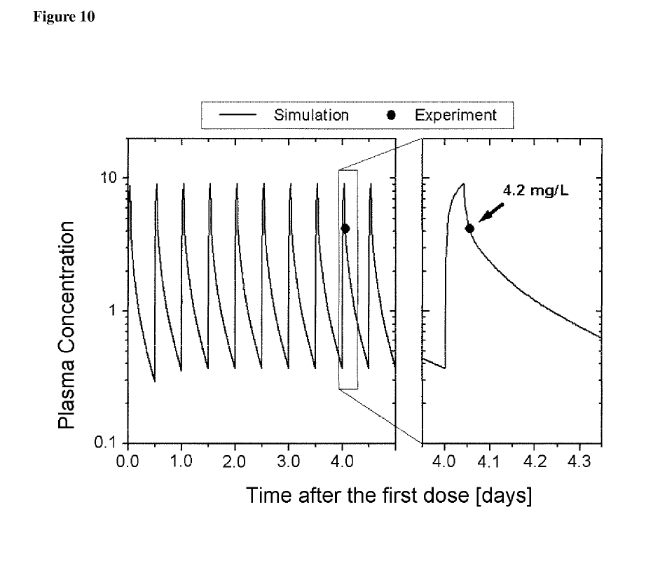

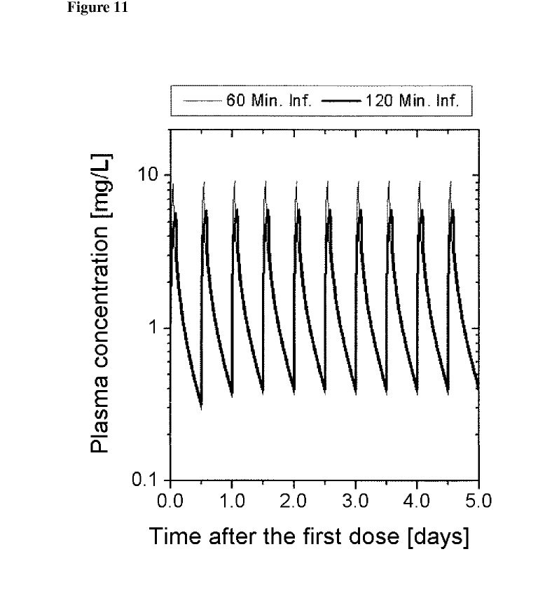

Because of the reported normal kidney and liver functions, the mean plasma clearance of ciprofloxacin in an adult was taken to be 7.6 ml/min/kg. The simulation of the described dose plan (see FIG. 10) in the severely overweight patient resulted, for the time quoted for samples being taken, in a plasma concentration of 4.1 mg/L, which virtually exactly matches the experimentally determined value (4.2 mg/L). This match is further evidence of the validity of the simulation model. Furthermore, the simulation shows that the time at which the samples were taken (20 minutes after the end of an infusion) does not (as intended) reflect the maximum ciprofloxacin concentration in the course of the therapy, because of the rapid distribution kinetics of ciprofloxacin. The simulated maximum concentration in the plasma at the end of an infusion was about 9.2 mg/L in equilibrium, and was therefore considerably higher than the measured value at the time when the samples were taken, and, furthermore, was very close to the toxicologically relevant limit value of 10 mg/L. For safety reasons, an infusion over a longer time period, for example over two hours, would have been preferable (this dose plan is illustrated comparatively in FIG. 11). This example demonstrates the superiority of the patient-specific calculation of the dose and of the dose plan on the basis of physiology-based pharmacokinetic models in comparison to the conventional, empirical approach, which makes use of comparative situations that are as similar as possible, described in the literature. In this specific case, the similarity of the patient to be treated (body weight 226 kg) was only slightly linked to the published range of patients (mean body weight 111 kg). The estimate of the total dose of Ciprofloxacin to be administered admittedly led to a good result (800 mg as a single dose twice daily), but the chosen dose plan led to maximum concentrations which were very close to the toxicologically relevant threshold value. This could have been prevented by using the apparatus according to the invention.

D: Dosage for Co-Medication: Paclitaxel und Cyclosporin

The risk of interactions between medicaments administered at the same time is particularly high in seriously ill and multimorbid patients. Numerous interaction studies exist, for example with known inhibitors of the p-glykoprotein-transporter systems (Pgp), which take place, for example, in the intestines where they can influence the absorption of orally administrated active substances or can have an influence on the excretion in the liver. Important known Pgp inhibitors are ketoconazol, verapamil or cyclosporin. The example of the interaction of paclitaxel with cyclosporin is used in the following text to show that the pharmacokinetic effect can be described quantitatively with high accuracy by means of the physiology-based simulation.

Paclitaxel is a cancer medicament which is a substrate for Pgp. When paclitaxel is administered orally, the Pgp associated active efflux leads to relatively low bio-availability of about 3%. When the Pgp inhibitor such as cyclosporin is administered at the same time, the active efflux is constrained, leading to an increase by about 7 times in the systematic exposition of paclitaxel (bio-availability about 22%). This clinical finding can be quantitatively understood using the physiology-based pharmacokinetic simulation model PK-Sim®.

Table 3 shows pharmacokinetic parameters such as systemic exposition (expressed as the area under the plasma concentration time curve, AUC), maximum plasma concentration (Cmax), as well as the times from which the plasma concentration was above 0.1 μM and 0.5 μM. The calculated values matched the experimentally measured values very well.

TABLE 3

| | Parameter | Measured | PK-Sim |
|---|---|---|---|
| paclitaxel without | AUC (μM*h) | 0.2 ± 0.1 | 0.167 |
| co-medication | Cmax (μM) | 0.1* | 0.05 |
| | T > 0.1 μM (h) | 0 | 0 |
| | T > 0.5 μM (h) | 1.2 ± 0.9 | 1.1 |
| paclitaxel with | AUC (μM*h) | 1.7 ± 0.9 | 1.56 |
| co-medication | Cmax (μM) | 0.2 ± 0.1 | 0.25 |
| with cyclosporin | T > 0.1 μM (h) | 3.7 ± 2.3 | 4.0 |
| | T > 0.5 μM (h) | 7.4 ± 4.4 | 5.0 |

*rounded-up value

It is therefore possible to simulate the interaction of two medicaments administered at the same time. Dosage instructions can then easily be derived from the simulation. In the present case, by way of example, the recommendation based on the simulation would indicate that the paclitaxel dose should be reduced by 90% with co-medication with cyclosporin.

1. An apparatus for providing a medicament dose comprising an input unit (1) for inputting individual patient information (101); a calculation unit (2) for calculating the medicament dose and, if appropriate, the optimum dose planned, and an automatic apparatus, connected thereto, for dosing of medicaments (3),
wherein the medicament dose is calculated in the calculation unit (2) by means of a rational mathematical simulation model (205) using physiological information (201), pathological information (202), medicament-specific information (203) and, if appropriate, information relating to additionally supplied medicaments (204) which information is available in the calculation unit (2).

2. The apparatus as claimed in claim 1, wherein the input unit (1) is a handheld device for manually inputting the individual patient information (101) or a smart-card reader for reading the individual patient information (101).

3. The apparatus as claimed in claim 1, wherein the rational mathematical model (205) is selected from allometric scaling functions of physiologically-based pharmacolinetic models.

4. The apparatus as claimed in claim 3, wherein the rational mathematical model (205) is a dynamically generated physiologically-based pharmacokinetic/pharmacodynamic simulation model.

5. The apparatus as claimed in claim 1, wherein the individual patient information (101) is selected from age, sex, race, body weight, body size, body mass index, lean body mass fat free body mass, gene expression data, debilitations, allergies, medication, kidney function and liver function.

6. The apparatus as claimed in claim 1, wherein the physiological information (201) is selected from age, sex, race, body weight, body size, body mass index, lean body mass fat free body mass, gene expression data, debilitations, allergies, medication, kidney function and liver function.

7. The apparatus as claimed in claim 1, wherein the pathological information (202) is selected from age, sex, race, body weight, body size, body mass index, lead body mass fat free body mass, gene expression data, debilitations, allergies, medication, kidney function and liver function.

8. The apparatus as claimed in claim 1, wherein the medicament-specific information (203) is selected from lipophilia, free plasma fraction, blood plasma ratio, distribution volume, clearance, type of clearance, clearance proportions, type of excretion, dose plan, transporter substrate, PD end point and side effects.

9. The apparatus as claimed in claim 1, wherein the information relating to additionally supplied medicaments (204) is selected from lipophilia, free plasma fraction, blood plasma ratio, distribution volume, clearance, type of clearance, clearance proportions, type of excretion, dose plan, transporter substrate, PD end point and side effects.

10. The apparatus as claimed in claim 1, wherein the information is transmitted from the input unit (1) to the calculation unit (2) and/or from the calculation unit (2) to the apparatus for dosing of medicaments (3) without the use of wires.

11. A method for calculating a medicament dose on the basis of individual patient information (101), wherein the calculation of the medicament dose is carried out in a calculation unit by a rational mathematical simulation model (205) using physiological information (201), pathological information (202), medicament-specific information (203) and, if appropriate, information relating to additionally supplied medicaments (204) which are available in the calculation unit (2).
